(19) United States
(12) Patent Application Publication
(10) Pub. No.: US 2026/0074756 A1
(43) Pub. Date: Mar. 12, 2026

(54) METHODS FOR IMPROVING WIRELESS DEVICE BEAM PREDICTION PROCEDURES BASED ON A BEAM IDENTIFICATION UPDATE GUARD INTERVAL

(71) Applicant: Telefonaktiebolaget LM Ericsson (publ), Stockholm (SE)

(72) Inventors: Henrik RYDÉN, Stockholm (SE); Andreas NILSSON, Göteberg (SE); Roy TIMO, Kungsängen (SE)

(21) Appl. No.: 19/101,706

(22) PCT Filed: Aug. 11, 2023
(86) PCT No.: PCT/SE2023/050806

§ 371 Date: Feb. 6, 2025

Related U.S. Application Data
(60) Provisional application No. 63/397,709, filed on Aug. 12, 2022.

(51) Int. Cl. H04B 7/06; H04B 7/0408; H04W 72/044

(52) U.S. Cl. CPC H04B 7/0617; H04B 7/0408; H04B 7/0626; H04W 72/044

(57) ABSTRACT

A method, network node and wireless device (WD) to perform procedures based on a beam identification (ID) update guard interval are disclosed. According to one aspect, a method in a network node includes configuring a beam ID update guard period during which the WD is configured to assume that a same network node spatial filter is used during the beam ID update guard period unless otherwise indicated by the network node. The method also includes transmitting an indication of the configuration to the WD.

### TECHNICAL FIELD

The present disclosure relates to wireless communications, and in particular, to wireless device beam prediction procedures based on a beam identification (ID) update guard interval.

### BACKGROUND

The Third Generation Partnership Project (3GPP) has developed and is developing standards for Fourth Generation (4G) (also referred to as Long Term Evolution (LTE)), Fifth Generation (5G) (also referred to as New Radio (NR)), and Sixth Generation (6G) wireless communication systems. Such systems provide, among other features, broadband communication between network nodes, such as base stations, and mobile wireless devices (WD) such as user equipment (UE), as well as communication between network nodes and between WDs.

One of the features of NR, compared to previous generation of wireless networks, is the ability to operate at higher frequencies (e.g., above 10 GHz). The available large transmission bandwidths in these frequency ranges may potentially provide large data rates. However, as carrier frequency increases, both pathloss and penetration loss increase. To maintain the coverage at the same level, highly directional beams are required to focus the radio transmitter energy in a particular direction on the receiver. However, large radio antenna arrays—at both receiver and transmitter sides—are needed to create such highly direction beams.

Large antenna arrays for high frequencies use time-domain analog beamforming, e.g., to reduce hardware costs. A core idea of analog beamforming is to share a single radio frequency chain between many (or, potentially, all) of the antenna elements. A limitation of analog beamforming is that it is only possible to transmit radio energy in using one beam (in one direction) at a given time.

The above limitation requires the network node (NN) and WD to preform beam management procedures to establish and maintain suitable transmitter (Tx)/receiver (Rx) beam-pairs. For example, beam management procedures may be used by a transmitter to sweep a geographic area by transmitting reference signals on different candidate beams, during non-overlapping time intervals, using a predetermined pattern. Further, by measuring the quality of these reference signals at the receiver side, the best transmit and receive beams may be identified.

### NR Beam Management Procedures

Beam management procedures in NR may defined by a set of L1/L2 procedures (i.e., Open Systems Interconnection Layer 1 (also known as the physical layer) and/or Layer 2 (also known as the medium access control (MAC) layer) procedures) that establish and maintain suitable beam pairs for transmitting and receiving data. A beam management procedure may include one or more sub procedures such as beam determination, beam measurements, beam reporting, and beam sweeping.

In cases of downlink transmission from the NN to the WD, P1/P2/P3 beam management procedures (defined below) may be performed, e.g., according to NR study item (SI) technical reports (TRs) such as 3GPP TR 38.802, V14.2.0, etc. P1/P2/P3 beam management procedures may be performed to overcome the challenges of establishing and maintaining the beam pairs when, for example, a WD moves or some blockage in the environment requires changing the beams. Although these scenarios are not directly mentioned in specifications of 3GPP, there are relevant procedures defined which may enable the realization of these scenarios.
P1: The P1 procedure may be used to enable WD measurement on different transmission/reception point (TRP) transmit (Tx) beams to support selection of TRP Tx beams/WD receive (Rx) beam(s). During initial access, for example, the network node (e.g., gNB) transmits synchronization signal/physical broadcast channel (SS/PBCH) block (SSB) beams in different directions to cover the whole cell. The WD may measure signal quality on corresponding SSB signals to detect and select an appropriate SSB beam, as shown in FIG. 1. Random access may then be transmitted on random access channel (RACH) resources indicated by a selected SSB. The corresponding beam may be used by both the WD and the network node to communicate until connected mode beam management is active. The network node may infer which SSB beam was chosen by the WD without any explicit signaling. FIG. 1 is an example of SSB beam selection as part of initial access procedure according to a P1 scenario:
   For beamforming at a TRP, an intra/inter-TRP Tx beam sweep from a set of different beams is typically included. For beamforming at the WD, a WD Rx beam sweep from a set of different beams is typically included;
P2: The P2 procedure may be used to enable WD measurement on different TRP Tx beams to possibly change inter/intra-TRP Tx beam(s). The network node may use the SSB beam as an indication of which (narrow) channel state information reference signal (CSI-RS) beams to try. That is, the selected SSB beam may be used to define a candidate set of narrow CSI-RS beams for beam management. Once CSI-RSs are transmitted, the WD may measure the reference signal received power (RSRP) and report the result to the network. If the network receives a CSI RSRP report from the WD that shows that a new CSI-RS beam is better than the old used to transmit a physical downlink control channel and a physical downlink shared channel (PDCCH/PDSCH), the network may update the serving beam for the WD accordingly and/or modify the candidate set of CSI-RS beams. The network node may also instruct the WD to perform measurements on SSBs. If the network receives a report from the WD that shows that a new SSB beam is better than the previous best SSB beam, a corresponding update of the candidate set of CSI-RS beams for the WD may be motivated:
   P2 procedure may be performed on a possibly smaller set of beams for beam refinement than in P1. Note that P2 may be a special case of P1. For example, in connected mode, the network node (e.g., gNB) may configure the WD with different CSI-RSs and transmit each CSI-RS on a corresponding beam. The WD may then measure the quality of each CSI-RS beam on its current Rx beam and send feedback about the quality of the measured beams. Thereafter, based on this feedback, the network node (e.g., gNB) may decide and/or indicate to the WD which beam will be used in future transmissions. This is shown in FIG. 2.
P3: may be used to enable WD measurement on the same TRP Tx beam to change WD Rx beam in the case WD uses beamforming. Once in connected mode, the WD may be configured with a set of reference signals. Based on measurements, the WD may determine which Rx beam is suitable to receive each reference signal in the set. The network node may then indicate which reference signals are associated with the beam that will be used to transmit physical downlink control channel (PDCCH) and/or physical downlink shared channel (PDSCH), and the WD may this information to adjust its Rx beam when receiving PDCCH/PDSCH. FIG. 3 shows an example of WD Rx beam selection for a corresponding CSI-RS Tx beam in downlink according to a P3 scenario:
   In connected mode, P3 may be used by the WD to find the best Rx beam for a corresponding Tx beam. In this case, the network node (e.g., gNB) keeps one CSI-RS Tx beam at a time, and WD may perform the sweeping and measurements on its own Rx beams for that specific Tx beam. The WD may then find the best corresponding Rx beam based on the measurements and will use it in future for reception when the network node (e.g., gNB) indicates the use of that Tx beam.

### Beam Measurement and Reporting in NR

For beam management, a WD may be configured to report Reference Signal Received Power (RSRP) or/and Signal to Interference plus Noise Ratio (SINR) for each one of up to four beams, either on CSI-RS or SSB. WD measurement reports may be sent either over a physical uplink control channel (PUCCH) or a physical uplink shared channel (PUSCH) to the network node, e.g., gNB.

### Reference Signal Configurations in NR

### CSI-RS:

A CSI-RS may be transmitted over each transmit (Tx) antenna port at the network node and for different antenna ports. The CSI-RS may be multiplexed in the time, frequency, and code domain such that the channel between each Tx antenna port at the network node and each receive antenna port at a WD may be measured by the WD. The time-frequency resource used for transmitting CSI-RS may be referred to as a CSI-RS resource.

In NR, the CSI-RS for beam management may be defined as a 1- or 2-port CSI-RS resource in a CSI-RS resource set where a field repetition is present. The following three example types of CSI-RS transmissions are supported:
Periodic CSI-RS: CSI-RS is transmitted periodically in certain slots. This CSI-RS transmission is semi-statically configured using radio resource control (RRC) signaling with parameters such as CSI-RS resource, periodicity, and slot offset;
Semi-Persistent CSI-RS: Similar to periodic CSI-RS, resources for semi-persistent CSI-RS transmissions are semi-statically configured using RRC signaling with parameters such as periodicity and slot offset. However, unlike periodic CSI-RS, dynamic signaling may be needed to activate and deactivate the CSI-RS transmission.
Aperiodic CSI-RS: This is a one-shot CSI-RS transmission that may happen in any slot. Here, one-shot means that CSI-RS transmission may only happens once per trigger. The CSI-RS resources (i.e., the resource elements (RE) locations which consist of subcarrier locations and orthogonal frequency-division multiplexing (OFDM) symbol locations) for aperiodic CSI-RS may be semi-statically configured. The transmission of aperiodic CSI-RS is triggered by dynamic signaling through PDCCH using the CSI request field in uplink (UL) downlink control information (DCI), in the same DCI where the UL resources for the measurement report are scheduled. Multiple aperiodic CSI-RS resources may be included in a CSI-RS resource set, and the triggering of aperiodic CSI-RS may be on a resource set basis.

### SSB:

In NR, an SSB may include a pair of synchronization signals (SSs), physical broadcast channel (PBCH), and demodulation (DMRS) for PBCH. An SSB is mapped to four consecutive OFDM symbols in the time domain and 240 contiguous subcarriers (20 RBs) in the frequency domain.

NR supports beamforming and beam-sweeping for SSB transmission by enabling a cell to transmit multiple SSBs in different narrow-beams multiplexed in time. The transmission of these SSBs may be confined to a half frame time interval (5 ms). It is also possible to configure a cell to transmit multiple SSBs in a single wide-beam with multiple repetitions. The design of beamforming parameters for each of the SSBs within a half frame is up to network implementation. The SSBs within a half frame may be broadcasted periodically from each cell. The periodicity of the half frames with SS/PBCH blocks may be referred to as SSB periodicity, which may be indicated by SIB1.

The maximum number of SSBs within a half frame, denoted by L, may depend on the frequency band, and the time locations for these L candidate SSBs within a half frame may depend on the SCS of the SSBs. The L candidate SSBs within a half frame may be indexed in an ascending order in time from 0 to L−1. By successfully detecting PBCH and its associated DMRS, a WD may know the SSB index. A cell does not necessarily transmit SS/PBCH blocks in all L candidate locations in a half frame, and the resource of the un-used candidate positions may be used for the transmission of data or control signaling instead. It is up to network implementation to decide which candidate time locations to select for SSB transmission within a half frame, and which beam to use for each SSB transmission.

### Measurement Resource Configurations in NR

A WD may be configured with the following:
N≥1 CSI reporting settings (CSI-ReportConfig); and/or
M≥1 resource settings (CSI-ResourceConfig).

Each CSI reporting setting may be linked to one or more resource settings for channel and/or interference measurement. The CSI framework may be modular in the sense that several CSI reporting settings may be associated with the same Resource Setting.

The measurement resource configurations for beam management may be provided to the WD by an RRC information element (IE) (CSI-ResourceConfigs). One CSI-ResourceConfig contains several NZP-CSI-RS-ResourceSets and/or CSI-SSB-ResourceSets.

A WD may be configured to measure CSI-RSs using the RRC IE NZP-CSI-RS-ResourceSet. A NZP CSI-RS resource set contains the configurations of Ks≥1 CSI-RS resources. Each CSI-RS resource configuration resource includes at least the following:
mapping to REs,
the number of antenna ports; and
time-domain behavior.

Up to 64 CSI-RS resources may be grouped together in an non-zero power (NZP)-CSI-RS-ResourceSet.

A WD may be configured to measure SSBs using the RRC IE CSI-SSB-ResourceSet. Resource sets that include SSB resources may be defined in a similar manner as the CSI-RS resources defined above.

In the case of aperiodic CSI-RS and/or aperiodic CSI reporting, the network node may configure the WD with S_c CSI triggering states. Each triggering state may include the aperiodic CSI report setting to be triggered along with the associated aperiodic CSI-RS resource sets.

Periodic and semi-persistent resource settings may only include a single resource set (i.e., S=1). Aperiodic resource settings may have many resources sets (S>=1), e.g., because one out of the S resource sets defined in the resource setting is indicated by the aperiodic triggering state that triggers a CSI report.

### Measurement Reporting

Three types of CSI reporting may be supported in NR:
Periodic CSI Reporting on PUCCH: CSI may be reported periodically by a WD. Parameters such as periodicity and slot offset may be configured semi-statically by higher layer RRC signaling from the network node to the WD;
Semi-Persistent CSI Reporting on PUSCH or PUCCH: similar to periodic CSI reporting, semi-persistent CSI reporting has a periodicity and slot offset which may be semi-statically configured. However, a dynamic trigger from network node to WD may be needed to allow the WD to begin semi-persistent CSI reporting. A dynamic trigger from network node to WD is needed to request the WD to stop the semi-persistent CSI reporting; and
Aperiodic CSI Reporting on PUSCH: This type of CSI reporting involves a single-shot (i.e., one time) CSI report by a WD which may be dynamically triggered by the network node using DCI. Some of the parameters related to the configuration of the aperiodic CSI report is semi-statically configured by RRC but the triggering is dynamic.

In each CSI reporting setting, the content and time-domain behavior of the report may be defined, along with the linkage to the associated Resource Settings.

The CSI-ReportConfig IE includes the following configurations:
reportConfigType
   Defines the time-domain behavior (periodic CSI reporting, semi-persistent CSI reporting, or aperiodic CSI reporting) along with the periodicity and slot offset of the report for periodic CSI reporting;
reportQuantity
   Defines the reported CSI parameters—the CSI content; for example, the precoder matrix indicator (PMI), channel quality indicator (CQI), rank indicator (RI), layer indicator (LI), CSI-RS resource index (CRI) and L1-RSRP. Only certain combinations are possible; for example, ‘cri-RI-PMI-CQI’ may be one possible value and ‘cri-RSRP’ may be another) and each value of reportQuantity may correspond to a certain CSI mode;
codebookConfig
   Defines the codebook used for PMI reporting, along with possible codebook subset restriction (CBSR). NR supported the following two types of PMI codebooks: Type I CSI and Type II CSI. Additionally, the Type I and Type II codebooks each may be two different variants: regular and port selection; and
reportFrequencyConfiguration
   Defines the frequency granularity of PMI and CQI (wideband or subband), if reported, along with the CSI reporting band, which is a subset of subbands of the bandwidth part (BWP) which the CSI corresponds to.
Measurement restriction in time domain (ON/OFF) for channel and interference respectively

For beam management, a WD may be configured to report L1-RSRP for up to four different CSI-RS/SSB resource indicators. The reported RSRP value corresponding to the first (best) CRI/SSBRI requires 7 bits, using absolute values, while the others require 4 bits using encoding relative to the first. In NR release 16, the report of L1-SINR for beam management has already been supported.

### 3GPP Considerations

The 3GPP has decided to study artificial intelligence and/or machine learning (AI/ML) based spatial beam prediction, the core idea of which is as follows: Predict the “best” beam (or beams) from a Set A of beams using measurement results from another Set B of beams.

Set A and Set B of beams have not been defined yet (left for future study). However, the following two examples illustrate some scenarios that may be studied in 3GPP Technical Release 18 (3GPP Rel-18):
Set B is a subset of a Set A. For example, Set A is a set of 8 SSB/CSI-RS beams shown in FIG. 4 (both black and white circles). More specifically, FIG. 4 shows an example where Set B (black circles) is a subset of Set A. A grid-of-beam type radiation pattern is shown: Each row (resp. column) depicts a certain zenith (resp. azimuth) angle from the antenna array. Set A has 8 beams and Set B has 4 beams (indicated by black circles). The WD measures the four beams of Set B. The AI/ML model should predict the best beam (or beams) in Set A using only measurements from Set B; and
Set A and Set B may correspond to two different sets of beams. For example, Set A may be a set of 30 narrow CSI-RS beams, and Set B may be a set of 8 wide SSB beams. The WD may measure beams in Set B and the AI/ML model may predict the best beam(s) from Set A. FIG. 5 shows an example of a Set A that is a set of narrow beams and a Set B that is a set of wide beams.

The spatial beam prediction may be performed in the network node (e.g., gNB) and/or the WD—a study item may cover both scenarios. The prediction may be based on L1-RSRP estimates for each beam. A study item may, however, also include additional assistance information to help AI/ML model training and inference. For example, a network node may provide beam shape assistance information (e.g., Tx beam shapes) to the WD. Beam shape information may enable the WD to collect and label beam management data (e.g., L1-RSRPs) for the purpose of designing, training, and deploying spatial/temporal beam prediction AI/ML models to WDs.

The following list summarizes different types of assistance information proposed within the 3GPP:
Tx and/or Rx beam shape information (e.g., Tx and/or Rx beam pattern, Tx and/or Rx beam boresight direction (azimuth and zenith angles from the array), 3 dB beamwidth, etc.);
expected Tx and/or Rx beam for the prediction (e.g., expected Tx and/or Rx angle, Tx and/or Rx beam ID for the prediction);
WD position information;
WD direction information;
Tx beam usage information; and
WD orientation information.

Note that providing Tx and/or Rx beam shape and/or angles as assistance information for training AI/ML models may be problematic. For example, sharing such information may leak information about proprietary beamforming solutions and compromise performance differentiations between different vendors. Moreover, such information may not always be well defined: A “beam” cannot always be described using a beam boresight direction and beam width. Indeed, NR specifications do not explicitly define “beams” for beam management, and, instead, use the transmission configuration indicator (TCI) framework to enable the P1/P2/P3 procedures.

Further, a network node may indicate a beam configuration identifier or beam ID to the WD. In other words, the network node may associate different SSB/CSI-RS beams with different beam IDs. The network node may share the beam IDs with the WD whenever the WD needs to know how the SSB/CSI-RS is beamformed. The WD does not know how the SSB/CSI-RS is beamformed but may assume that any two reference signals with the same beam ID have been beamformed in the same way.

A basic problem with beam ID assistance information is as follows: The network node may dynamically update beamforming weights for SSB and/or CSI-RS to, for example, to adapt to changing propagation conditions and/or traffic loads, and/or turn off part of the panel to reduce the heat/save energy. The WD, however, may only be provided with beam ID assistance information (for example a list of reference signals and/or beam IDs); and the WD may not be provided with any explicit information (e.g., beam widths and/or pointing angles) about how the SSB and/or CSI-RS is beamformed. If SSB/CSI-RS beamforming weights are dynamically updated, then it is not clear how they may be reliably connected to semi-static beam IDs.

For example, if the network node updates the beam pattern for all or a subset of its beam IDs, the performance of that AI/ML based beam prediction may not work, e.g., a WD using an AI/ML model for beam prediction where the AI/ML model has been trained based on the on the previous beam patterns. A new beam IDs for each new beam pattern may be is used by the network node. However, the number of beam IDs may grow rapidly if the network node allocates a new ID for every SSB/CSI-RS beamforming weight update, thereby leading to unnecessarily large control overhead and difficulties for WD-sided data collection and AI/ML model training/retraining.

Another problem of large amount of beam IDs is that signaling overhead of sending the beam IDs to the WD increases. For example, if 1024 unique beam IDs are supported/captured, this would require standardizing a 10-bit beam ID field. Another related issue is the risk of beam ID collisions, i.e., that two different beams would get identical beam IDs. This occurs when the beam IDs for such 10-bit field is “full” and the network node may have to reuse another ID (which may make the models using such IDs outdated and performance to degrade).

### SUMMARY

Some embodiments advantageously provide methods, network nodes and wireless devices (WD) configured to perform a WD beam prediction process based on a beam ID update guard interval. Some embodiments reduce overhead associated with beam ID based predictions, e.g., by first introducing a set of unique beam IDs and/or a beam ID update guard period, X. In some embodiments, an explicit beam ID is used. In some embodiments, a beam ID represented by a downlink reference signal ID (e.g., CRI, SSB block resource indicator (SSBRI), or similar downlink reference signal in 6G) may be used. Some embodiments provide simplicity and low overhead. Some embodiments, enable WD/chipset vendors with SSB/CSI-RS meta data to adapt to network configuration changes for SSB and CSI-RS beamforming.

One advantage of some embodiments is reduced signaling overhead, where the beam ID signaled to the device is limited to a predetermined bit representation, e.g., a 5-bit representation. Known systems rely on a process where the quantity of unique beam IDs may grow large over time requiring allocation of a large bit-vector to support signaling of a large set of unique beam IDs. Some embodiments of the present disclosure provide more efficient signaling (e.g., fewer bits) such as by including extra information in the guard period. Another advantage of some embodiments of the present disclosure is mitigation of the potential for beam ID collisions, i.e., that two different beams would get identical beam IDs.

In some embodiments, a single bit indication (is_new_precoder) may be used to indicate to a WD whether a certain beam ID has changed beam pattern or not. Use of a single bit indication demands less overhead than exists in known systems. By using the single bit indication (is_new_precoder), which is beam ID-specific, the WD receives an indication of which Beam ID has changed. The WD may choose to collect (e.g., only collect) data to update the AI/ML model for the beam IDs that are changed (since the WD may already have data collected for the unchanged beam IDs).

According to one aspect, a network node configured to communicate with a wireless device, WD, is provided. The network node is configured to configure a beam ID update guard period during which the WD is configured to assume that a same network node spatial filter is used during the beam ID update guard period unless otherwise indicated by the network node. The network node is configured to transmit an indication of the configuration to the WD.

According to this aspect, in some embodiments, the network node is further configured to update an association between beam patterns and a set of beam identifiers during the beam ID update guard period, transmit to the WD an indication of the association when the beam ID update guard period has expired. In some embodiments, the network node is further configured to update a beam pattern identified by at least one beam identifier of the set of beam identifiers. In some embodiments, the network node is further configured to trigger the WD to determine a precoder for a corresponding beam identifier of the set of beam identifiers for which the association has been updated. In some embodiments, the network node is further configured to receive a request from the WD for the network node not to update a beam pattern for the set of beam identifiers during the beam ID update guard period. In some embodiments, the network node is further configured to transmit a first set of reference signals associated with the set of beam identifiers, the transmitted first set of reference signals triggering the WD to train a beam prediction model to predict a best beam. In some embodiments, the network node is further configured to transmit a second set of reference signals associated with a subset of the set of beam identifiers, the transmitted second set triggering the WD to predict a best beam based at least in part on a beam prediction model. In some embodiments, the network node is further configured to indicate that an association update has occurred via a precoder flag. In some embodiments, the precoder flag is appended to an n-bit field, each bit in the n-bit field being set to true when an associated beam has been updated and being set to false when the associated beam has not been updated. In some embodiments, the network node is further configured to map the set of beam identifiers to corresponding precoders. In some embodiments, the network node is further configured to indicate the set of beam identifiers in a channel state information, CSI, report. In some embodiments, the network node is further configured to configure the set of beam identifiers in a transmission configuration indicator, TCI, state. In some embodiments, the association is indicated by an update counter. In some embodiments, the set of beam identifiers include at least one of a reference signal index or a synchronization signal/physical broadcast channel, SSB, resource index.

According to another aspect, a method in a network node configured to communicate with a wireless device, WD, is provided. The method includes: configuring a beam ID update guard period during which the WD is configured to assume that a same network node spatial filter is used during the beam ID update guard period unless otherwise indicated by the network node; and transmitting an indication of the configuration to the WD.

According to this aspect, in some embodiments, the method includes updating an association between beam patterns and a set of beam identifiers during a beam ID update guard period, and transmitting to the WD an indication of the association when the beam ID update guard period has expired. In some embodiments, the method includes updating a beam pattern identified by at least one beam identifier of the set of beam identifiers. In some embodiments, the method includes triggering the WD to determine a precoder for a corresponding beam identifier of the set of beam identifiers for which the association has been updated. In some embodiments, the method includes receiving a request from the WD for the network node not to update a beam pattern for the set of beam identifiers during the beam ID update guard period. In some embodiments, the method includes transmitting a first set of reference signals associated with the set of beam identifiers, the transmitted first set of reference signals triggering the WD to train a beam prediction model to predict a best beam. In some embodiments, the method includes transmitting a second set of reference signals associated with a subset of the set of beam identifiers, the transmitted second set triggering the WD to predict a best beam based at least in part on a beam prediction model. In some embodiments, the method includes indicating that an association update has occurred via a precoder flag. In some embodiments, the precoder flag is appended to an n-bit field, each bit in the n-bit field being set to true when an associated beam has been updated and being set to false when the associated beam has not been updated. In some embodiments, the method includes mapping the set of beam identifiers to corresponding precoders. In some embodiments, the method includes indicating the set of beam identifiers in a channel state information, CSI, report. In some embodiments, the method includes configuring the set of beam identifiers in a transmission configuration indicator, TCI, state. In some embodiments, the association is indicated by an update counter. In some embodiments, the set of beam identifiers include at least one of a reference signal index or a synchronization signal/physical broadcast channel, SSB, resource index.

According to yet another aspect, a wireless device, WD, configured to communicate with a network node is provided. The WD is configured to: receive from the network node a configuration of a beam ID update guard period; and assume that the network does not change the spatial filter associated with a set of beam identifiers during the beam ID update guard period unless indicated otherwise by the network node

According to this aspect, in some embodiments, the WD is configured to receive from the network node a precoder flag, the precoder flag indicating whether a beam pattern associated with a set of beam identifiers has been updated during a beam ID update guard period. In some embodiments, the WD is configured to, when the precoder flag indicates that a beam pattern associated with the set of beam identifiers has been updated: train a beam prediction model based at least in part on a first set of reference signals associated with the set of beam identifiers, each beam identifier of the set of beam identifiers having a precoder flag set to one of true and false. In some embodiments, the WD is further configured to transmit a request for the network node not to update a beam pattern for the set of beam identifiers during the beam update guard period. In some embodiments, the WD is further configured receive the first set of reference signals and receive a second set of reference signals associated with a subset of the set of beam identifiers. In some embodiments, the WD is further configured to train the beam prediction model in response to receiving the first set of reference signals. In some embodiments, the WD is further configured to train the beam prediction model in response to receiving the second set of reference signals. In some embodiments, the precoder flag is appended to an n-bit field, each bit in the n-bit field being set to true when an associated beam has been updated and being set to false when the associated beam has not been updated. In some embodiments, the WD is further configured to receive an indication of beams that have been updated in a channel state information, CSI, report. In some embodiments, the WD is further configured to receive a configuration of beams that have been updated in a transmission configuration indicator, TCI, state. In some embodiments, the first set of reference signals is indicated by at least one of a reference signal index or a synchronization signal/physical broadcast channel, SSB, resource index. In some embodiments, the WD is configured to predict a best beam based at least in part on the trained model and the first set of reference signals.

According to another aspect, a method in a wireless device, WD, configured to communicate with a network node is provided. The method includes receiving from the network node a configuration of a beam ID update guard period, and assuming that the network does not change the spatial filter associated with a set of beam identifiers during the beam ID update guard period unless indicated otherwise by the network node.

According to this aspect, in some embodiments, the method includes receiving a precoder flag, the precoder flag indicating whether a beam pattern associated with a set of beam identifiers has been updated during a beam ID update guard period. In some embodiments, the method includes, when the precoder flag indicates that a beam pattern associated with the set of beam identifiers has been updated: training a beam prediction model based at least in part on a first set of reference signals associated with the set of beam identifiers, each beam identifier of the set of beam identifiers having a precoder flag set to one of true and false. In some embodiments, the method includes transmitting a request for the network node not to update a beam pattern for the set of beam identifiers during the beam update guard period. In some embodiments, the method includes receiving the first set of reference signals and receive a second set of reference signals associated with a subset of the set of beam identifiers. In some embodiments, the method includes training the beam prediction model in response to receiving the first set of reference signals. In some embodiments, the method includes training the beam prediction model in response to receiving the second set of reference signals. In some embodiments, the precoder flag is appended to an n-bit field, each bit in the n-bit field being set to true when an associated beam has been updated and being set to false when the associated beam has not been updated. In some embodiments, the method includes receiving an indication of beams that have been updated in a channel state information, CSI, report. In some embodiments, the method includes receiving a configuration of beams that have been updated in a transmission configuration indicator, TCI, state. In some embodiments, the first set of reference signals is indicated by at least one of a reference signal index or a synchronization signal/physical broadcast channel, SSB, resource index. In some embodiments, the method includes predicting a best beam based at least in part on the trained model and the first set of reference signals.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 shows an example SSB beam selection as part of an initial access procedure according to a P1 scenario;

FIG. 2 shows an example of CSI-RS Tx beam selection in Downlink according to a P2 scenario;

FIG. 3 shows an example of WD Rx beam selection for a corresponding CSI-RS Tx beam in downlink according to a P3 scenario;

FIG. 4 shows an example of a Set B that is a subset of Set A;

FIG. 5 shows an example of a Set A that is a set of narrow beams and a Set B that is a set of wide beams.

FIG. 6 is a schematic diagram of an example network architecture illustrating a communication system connected via an intermediate network to a host computer according to the principles in the present disclosure;

FIG. 7 is a block diagram of a host computer communicating via a network node with a wireless device over an at least partially wireless connection according to some embodiments of the present disclosure;

FIG. 8 is a flowchart illustrating example methods implemented in a communication system including a host computer, a network node and a wireless device for executing a client application at a wireless device according to some embodiments of the present disclosure;

FIG. 9 is a flowchart illustrating example methods implemented in a communication system including a host computer, a network node and a wireless device for receiving user data at a wireless device according to some embodiments of the present disclosure;

FIG. 10 is a flowchart illustrating example methods implemented in a communication system including a host computer, a network node and a wireless device for receiving user data from the wireless device at a host computer according to some embodiments of the present disclosure;

FIG. 11 is a flowchart illustrating example methods implemented in a communication system including a host computer, a network node and a wireless device for receiving user data at a host computer according to some embodiments of the present disclosure;

FIG. 12 is a flowchart of an example process in a network node according to some embodiments of the present disclosure;

FIG. 13 is a flowchart of an example process in a wireless device according to some embodiments of the present disclosure;

FIG. 14 is a flowchart of another example process in a network node according to some embodiments of the present disclosure;

FIG. 15 is a flowchart of an example process in a wireless device according to some embodiments of the present disclosure;

FIG. 16 shows an example process according to some embodiments of the present disclosure;

FIG. 17 shows another example process according to some embodiments of the present disclosure;

FIG. 18 shows an example process according to some embodiments of the present disclosure; and

FIG. 19 shows another example process according to some embodiments of the present disclosure.

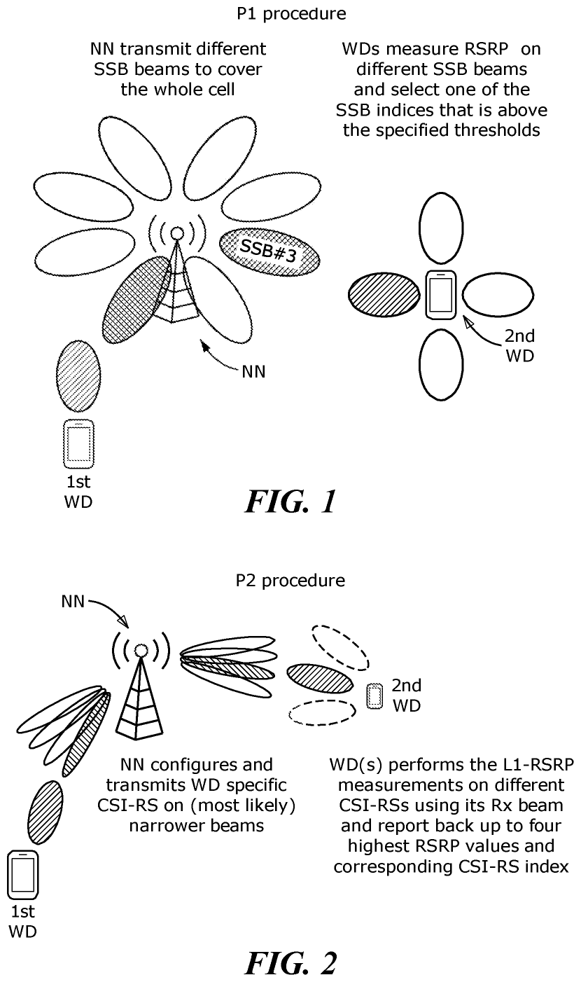

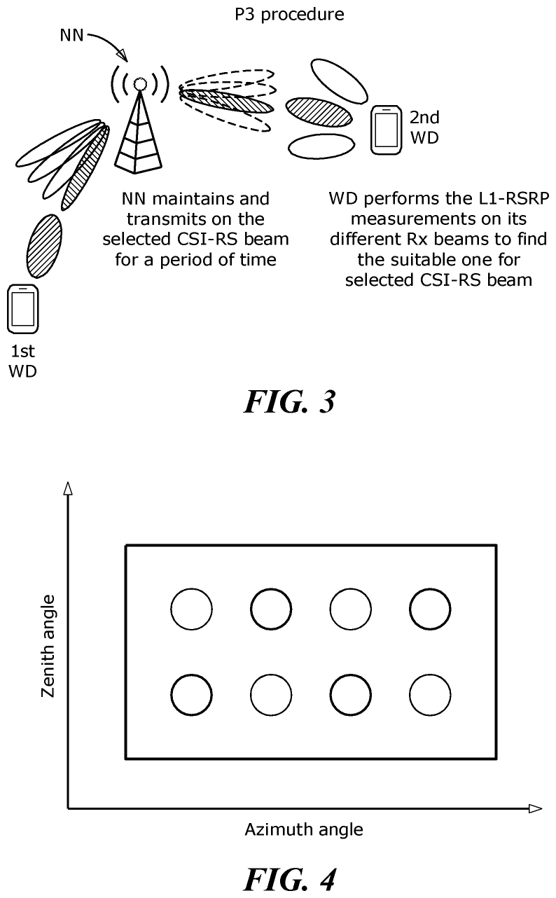

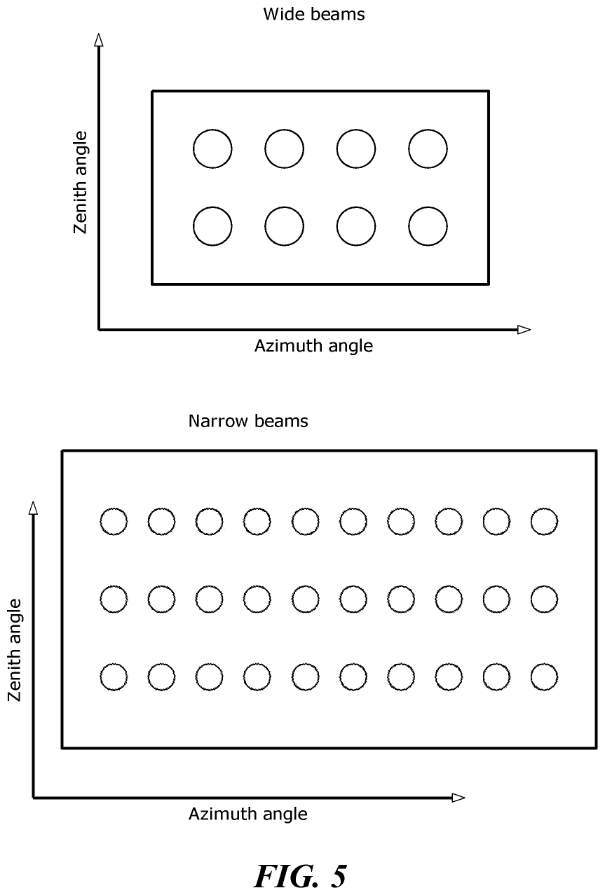

### DETAILED DESCRIPTION

Before describing in detail example embodiments, it is noted that the embodiments reside primarily in combinations of apparatus components and processing steps related to a WD beam prediction process, e.g., based on a beam ID update guard interval. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD).

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

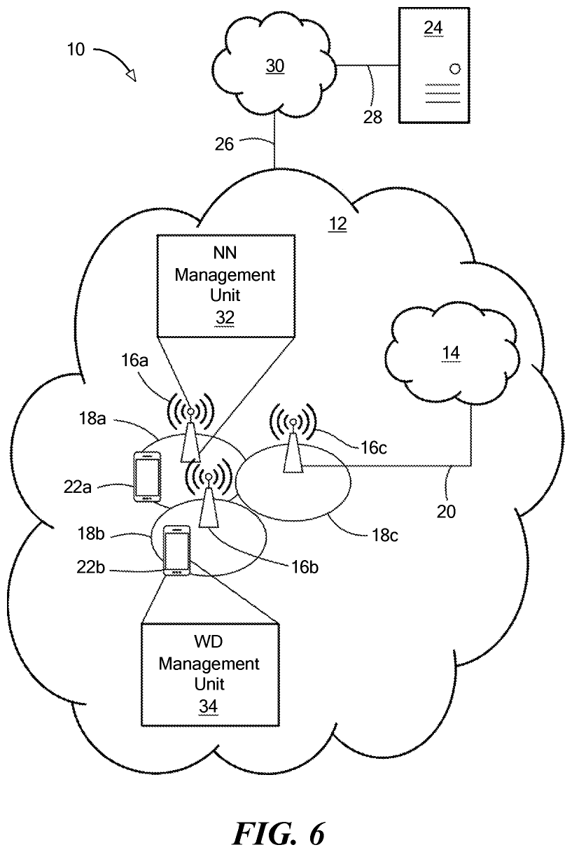

Referring again to the drawing figures, in which like elements are referred to by like reference numerals, there is shown in FIG. 6 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 6 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a NN management unit 32 which is configured to perform any step and/or task and/or process and/or method and/or feature described in the present disclosure, e.g., transmit a configuration to the WD 22, the configuration including a set of beam identifiers, each beam identifier of the set of beam identifiers having a precoder flag set to false; update a beam pattern of one or more beam identifiers of the set of beam identifiers; and transmit an indication to the WD 22 indicating the updated beam pattern of the one or more beam identifiers. In some embodiments, the NN management unit 32 is configured to configure a beam ID update guard period during which the WD (22) is configured to assume that a same network node spatial filter is used during the beam ID update guard period unless otherwise indicated by the network node. A wireless device 22 is configured to include a WD management unit 34 which is configured to perform any step and/or task and/or process and/or method and/or feature described in the present disclosure, e.g., perform a training of a model for beam prediction and/or predict a best beam from the set of beam identifiers. In some embodiments, the WD management unit 34 is configured to use assume that the network does not change the spatial filter associated with a set of beam identifiers during the beam ID update guard period unless indicated otherwise by the network node.

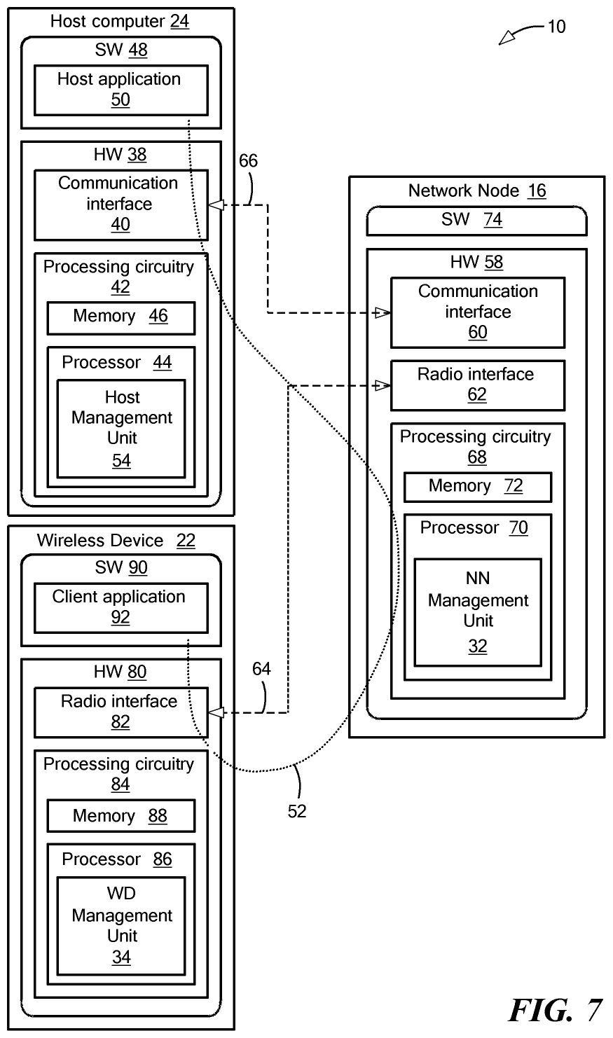

Example implementations, in accordance with an embodiment, of the WD 22, network node 16 and host computer 24 discussed in the preceding paragraphs will now be described with reference to FIG. 7. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In some embodiments, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a host unit 54 configured to enable the service provider to perform any step and/or task and/or process and/or method and/or feature described in the present disclosure, e.g., observe/monitor/control/transmit to/receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include NN management unit 32 configured to perform any step and/or task and/or process and/or method and/or feature described in the present disclosure, e.g., transmit a configuration to the WD 22, the configuration including a set of beam identifiers, each beam identifier of the set of beam identifiers having a precoder flag set to false; update a beam pattern of one or more beam identifiers of the set of beam identifiers; and transmit an indication to the WD 22 indicating the updated beam pattern of the one or more beam identifiers. In some embodiments, the NN management unit 32 is configured to configure a beam ID update guard period during which the WD (22) is configured to assume that a same network node spatial filter is used during the beam ID update guard period unless otherwise indicated by the network node.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a WD management unit 34 which is configured to perform any step and/or task and/or process and/or method and/or feature described in the present disclosure, e.g., perform a training of a model for beam prediction and/or predict a best beam from the set of beam identifiers The WD management unit 34 may be configured to configure a beam ID update guard period during which the WD (22) is configured to assume that the network does not change the spatial filter associated with a set of beam identifiers during the beam ID update guard period unless indicated otherwise by the network node.

In some embodiments, the inner workings of the network node 16, WD 22, and host computer 24 may be as shown in FIG. 7 and independently, the surrounding network topology may be that of FIG. 6.

In FIG. 7, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 6 and 7 show various “units” such as NN management unit 32, and WD management unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

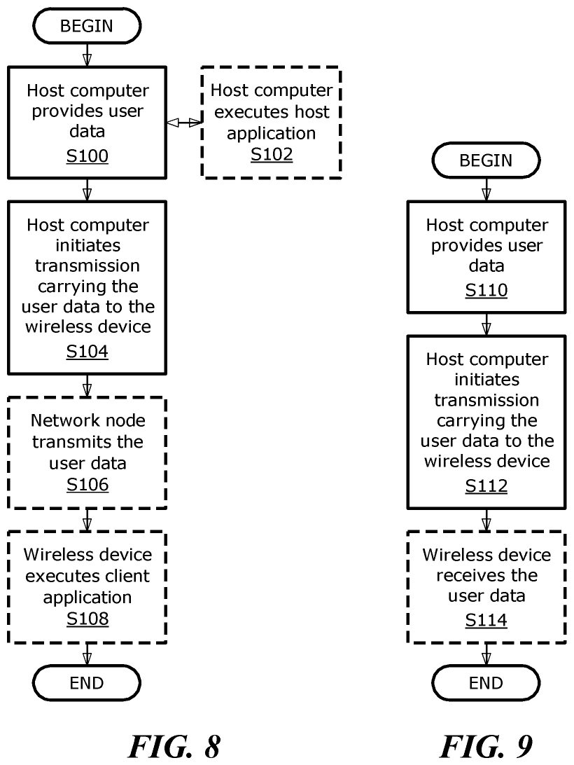

FIG. 8 is a flowchart illustrating an example method implemented in a communication system, such as, for example, the communication system of FIGS. 6 and 7, in accordance with some embodiments. The communication system may include a host computer 24, a network node 16 and a WD 22, which may be those described with reference to FIG. 7. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 9 is a flowchart illustrating an example method implemented in a communication system, such as, for example, the communication system of FIG. 6, in accordance with some embodiments. The communication system may include a host computer 24, a network node 16 and a WD 22, which may be those described with reference to FIGS. 6 and 7. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

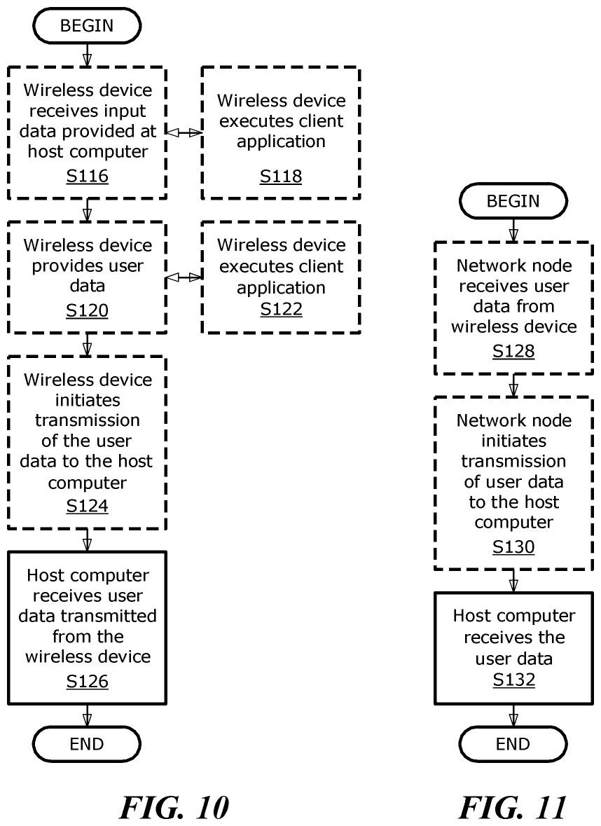

FIG. 10 is a flowchart illustrating an example method implemented in a communication system, such as, for example, the communication system of FIG. 6, in accordance with some embodiments. The communication system may include a host computer 24, a network node 16 and a WD 22, which may be those described with reference to FIGS. 6 and 7. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

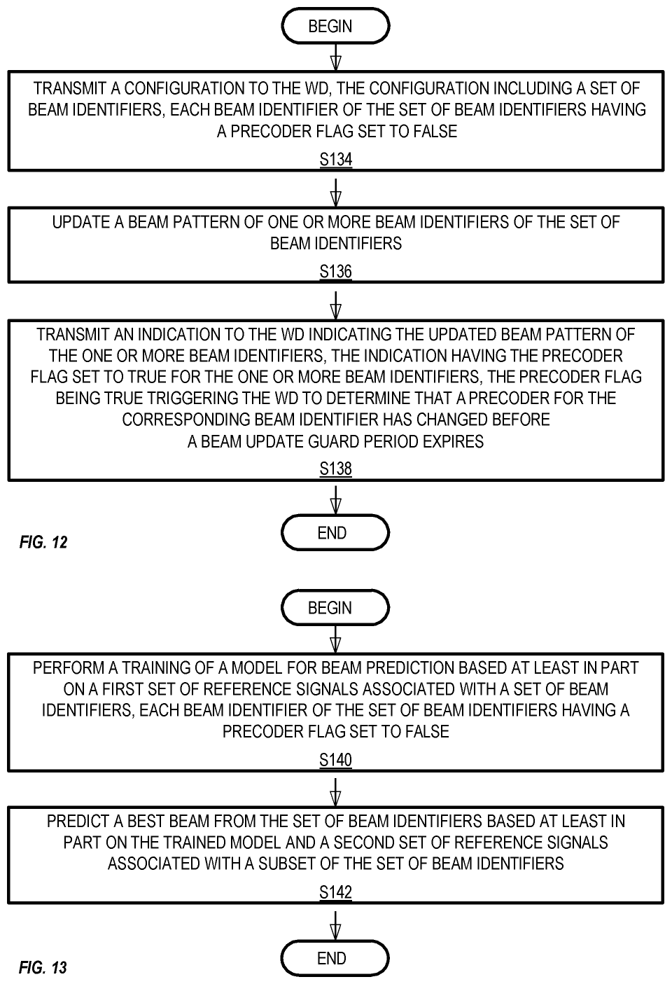

FIG. 11 is a flowchart illustrating an example method implemented in a communication system, such as, for example, the communication system of FIG. 6, in accordance with some embodiments. The communication system may include a host computer 24, a network node 16 and a WD 22, which may be those described with reference to FIGS. 6 and 7. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

FIG. 12 is a flowchart of an example process in a network node 16. One or more blocks described herein may be performed by one or more elements of network node 16 such as by one or more of processing circuitry 68 (including the NN management unit 32), processor 70, radio interface 62 and/or communication interface 60. Network node 16 such as via processing circuitry 68 and/or processor 70 and/or radio interface 62 and/or communication interface 60 is configured to transmit (Block S134) a configuration to the WD, the configuration including a set of beam identifiers, each beam identifier of the set of beam identifiers having a precoder flag set to false; update (Block S136) a beam pattern of one or more beam identifiers of the set of beam identifiers; and transmit an indication to the WD 22 indicating the updated beam pattern of the one or more beam identifiers, the indication having the precoder flag set to true for the one or more beam identifiers, the precoder flag being true triggering the WD 22 to determine that a precoder for the corresponding beam identifier has changed before a beam update guard period expires (Block 138).

In some embodiments, the transmitted assistance information triggers the WD 22 to perform a training of at least one model based at least in part on the indication. In some other embodiments, a method includes receiving a second request for additional assistance information associated with a third set of beam identifiers and transmitting the additional assistance information, the transmitted additional assistance information triggering the WD 22 to delete information related to at least one beam identifier of the third set of beam identifiers.

FIG. 13 is a flowchart of an example process in a wireless device 22 according to some embodiments. One or more blocks described herein may be performed by one or more elements of wireless device 22 such as by one or more of processing circuitry 84 (including the WD management unit 34), processor 86, radio interface 82 and/or communication interface 60. Wireless device 22 such as via processing circuitry 84 and/or processor 86 and/or radio interface 82 is configured to perform a training of a model for beam prediction based at least in part on a first set of reference signals associated with a set of beam identifiers, each beam identifier of the set of beam identifiers having a precoder flag set to false (Block S140); and predict a best beam from the set of beam identifiers based at least in part on the trained model and a second set of reference signals associated with a subset of the set of beam identifiers (Block S142).

In some embodiments, the method further includes transmitting a request for the network node not to update, during a beam update guard period, a beam pattern for the set of beam identifiers.

In some other embodiments, the method further includes receiving an indication indicating an updated beam pattern of one or more beam identifiers of the set of beam identifiers, the indication having the precoder flag set to true for the one or more beam identifiers; and determining that a precoder for at least one beam identifier has changed before the beam update guard period expired based on the received indication.

In some embodiments, the method includes at least one of: receiving a configuration, the configuration including the set of beam identifiers; receiving the first set of reference signals associated with the set of beam identifiers; and receiving the second set of reference signals associated with the subset of the set of beam identifiers.

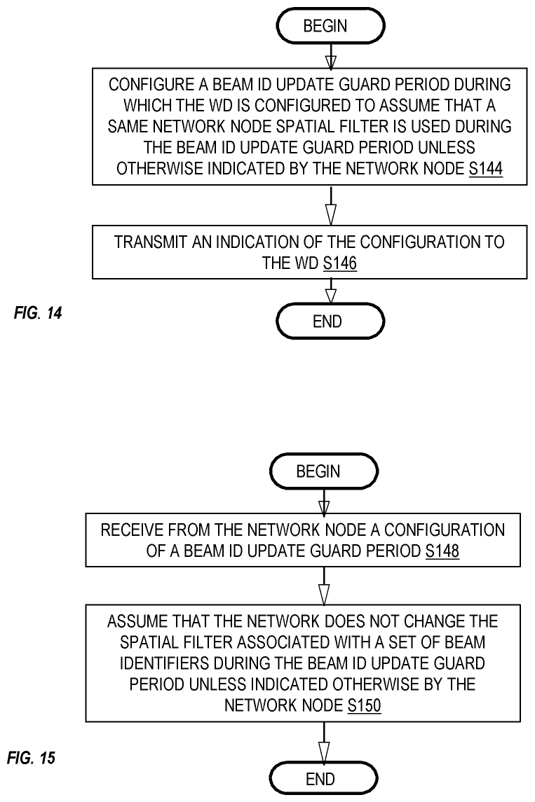

FIG. 14 is a flowchart of an example process in a network node 16. One or more blocks described herein may be performed by one or more elements of network node 16 such as by one or more of processing circuitry 68 (including the NN management unit 32), processor 70, radio interface 62 and/or communication interface 60. Network node 16 such as via processing circuitry 68 and/or processor 70 and/or radio interface 62 and/or communication interface 60 is configured to configure a beam ID update guard period during which the WD 22 is configured to assume that a same network node spatial filter is used during the beam ID update guard period unless otherwise indicated by the network node 16 (Block S144). The process includes transmitting an indication of the configuration to the WD 22 (Block S146).

In some embodiments, the method includes updating an association between beam patterns and a set of beam identifiers during a beam ID update guard period, and transmitting to the WD 22 an indication of the association when the beam ID update guard period has expired. In some embodiments, the method includes updating a beam pattern identified by at least one beam identifier of the set of beam identifiers. In some embodiments, the method includes triggering the WD 22 to determine a precoder for a corresponding beam identifier of the set of beam identifiers for which the association has been updated. In some embodiments, the method includes receiving a request from the WD 22 for the network node 16 not to update a beam pattern for the set of beam identifiers during the beam ID update guard period. In some embodiments, the method includes transmitting a first set of reference signals associated with the set of beam identifiers, the transmitted first set of reference signals triggering the WD 22 to train a beam prediction model to predict a best beam. In some embodiments, the method includes transmitting a second set of reference signals associated with a subset of the set of beam identifiers, the transmitted second set triggering the WD 22 to predict a best beam based at least in part on a beam prediction model. In some embodiments, the method includes indicating that an association update has occurred via a precoder flag. In some embodiments, the precoder flag is appended to an n-bit field, each bit in the n-bit field being set to true when an associated beam has been updated and being set to false when the associated beam has not been updated. In some embodiments, the method includes mapping the set of beam identifiers to corresponding precoders. In some embodiments, the method includes indicating the set of beam identifiers in a channel state information, CSI, report. In some embodiments, the method includes configuring the set of beam identifiers in a transmission configuration indicator, TCI, state. In some embodiments, the association is indicated by an update counter. In some embodiments, the set of beam identifiers include at least one of a reference signal index or a synchronization signal/physical broadcast channel, SSB, resource index.

FIG. 15 is a flowchart of an example process in a wireless device 22 according to some embodiments. One or more blocks described herein may be performed by one or more elements of wireless device 22 such as by one or more of processing circuitry 84 (including the WD management unit 34), processor 86, radio interface 82 and/or communication interface 60. Wireless device 22 such as via processing circuitry 84 and/or processor 86 and/or radio interface 82 is configured to receive from the network node 16 a configuration of a beam ID update guard period (Block S148). The process includes assuming that the network does not change the spatial filter associated with a set of beam identifiers during the beam ID update guard period unless indicated otherwise by the network node (Block S150).

According to this aspect, in some embodiments, the method includes receiving a precoder flag, the precoder flag indicating whether a beam pattern associated with a set of beam identifiers has been updated during a beam ID update guard period. In some embodiments, the method includes, when the precoder flag indicates that a beam pattern associated with the set of beam identifiers has been updated: training a beam prediction model based at least in part on a first set of reference signals associated with the set of beam identifiers, each beam identifier of the set of beam identifiers having a precoder flag set to one of true and false. In some embodiments, the method includes transmitting a request for the network node 16 not to update a beam pattern for the set of beam identifiers during the beam update guard period. In some embodiments, the method includes receiving the first set of reference signals and receive a second set of reference signals associated with a subset of the set of beam identifiers. In some embodiments, the method includes training the beam prediction model in response to receiving the first set of reference signals. In some embodiments, the method includes training the beam prediction model in response to receiving the second set of reference signals. In some embodiments, the precoder flag is appended to an n-bit field, each bit in the n-bit field being set to true when an associated beam has been updated and being set to false when the associated beam has not been updated. In some embodiments, the method includes receiving an indication of beams that have been updated in a channel state information, CSI, report. In some embodiments, the method includes receiving a configuration of beams that have been updated in a transmission configuration indicator, TCI, state. In some embodiments, the first set of reference signals is indicated by at least one of a reference signal index or a synchronization signal/physical broadcast channel, SSB, resource index. In some embodiments, the method includes predicting a best beam based at least in part on the trained model and the first set of reference signals.

Having described the general process flow of arrangements of the disclosure and having provided examples of hardware and software arrangements for implementing the processes and functions of the disclosure, the sections below provide details and examples of arrangements for a WD beam prediction process, e.g., based on a beam ID update guard interval.

In some embodiments, the overhead and robustness to beam ID based predictions is reduced, e.g.,. by introducing a set of unique beam IDs and/or a beam ID update guard period X. The beam ID update guard period X may be used in several different ways. For example, a WD 22, or a WD vendor may request a certain cell of the network to not update the beam patterns of the beam IDs during a time specified by the beam ID update guard period X. The network node 16 may then choose to follow the request or not. In another embodiment, the network node 16 initiates the beam ID update guard period X to one or more serving WDs 22, which indicates that network node 16 (e.g., gNB) may keep fixed beam patterns for the configured beam IDs within or for a certain time interval defined by the beam ID update guard period X.

In some embodiments, the network node 16 may be configured to use a single bit indication to indicate to the WD 22 or to all the WDs 22 belonging to a certain WD 22 vendor (e.g., assuming for example that all WDs 22 of a certain vendor may use the same trained AI/ML model)) whether the network has updated the beam pattern during the time defined of the beam ID update guard period X or not. The indication may be used, e.g., if the network node 16 has updated the beam pattern during the time defined by the beam ID update guard period X. In some embodiments, a single bit indication, referred to as is_new_precoder flag, may be used to indicate whether and for which WD beam IDs the network node 16 has updated the beam patterns (e.g., since the start of the beam ID update guard period X). The is_new_precoder flag may be associated with each beam ID, e.g., to indicate if the network node 16 has changed the beam pattern for that respective beam ID or not. For example, if:
is_new_precoder=False (0): The WD 22 may assume that the precoder weights for this beam ID have not changed within the beam ID update guard period (e.g., X=24 hours, during the last X=24 hours); and/or
is_new_precoder=True (1): The WD 22 may assume that the precoder for this beam ID has changed within the beam ID update guard period (e.g., X=24 hours, it has changed at least one during the last X=24 hours).

A beam ID update guard period X may be fixed (and/or defined in a standard) and/or dynamically configured by the network node 16. In one example, the update beam ID update guard period X=24 hours.

The WD 22 may then use the “beam IDs” and “is_new_precoder flag” to collect and organize SSB/CSI-RS measurement data for training and retraining AI/ML models.

In some embodiments, the is_new_precoder flag is used to indicate whether the precoder weights for this beam ID have been changed since a WD 22 entered the cell. This may be useful for example during online AI/ML training and inference, where the WD 22 trains the AI/ML beam management model and performs beam prediction of the trained AI/ML model during operation. The AI/ML model training (e.g., online AI/ML training and inference method) may, for example, be performed for the first X minutes in a cell. The WD 22 may apply the trained AI/ML model to perform beam predictions for the remaining time in that cell.

Further, the training of the AI/ML model (e.g., for the online AI/ML training and inference method) may be performed periodically during the operation. In case the network changes the precoder weights (beam patterns) for one or more of the beam IDs after the WD 22 has entered the cell, the WD 22 may retrain the AI/ML model for the beam IDs with new precoder weights. By using the is_new_precoder flag, the network node 16 may (e.g., in an overhead efficient way) indicate which of the beam IDs that it has changed precoding weights for (e.g., since the WD 22 may only need to collect data and re-train the AI/ML model for the beam IDs with new precoder weights). In some embodiments, the is_new_precoder flag may be updated using a medium access control (MAC) control element (CE) instead of RRC signaling. In some embodiments, the is_new_precoder flag may be toggled every time the precoding weights of a beam ID are changed. For example, the WD 22 may be configured with the parameter is_new_precoder flag set to zero for all beam IDs when it enters the cell. When the network node 16 changes the precoding weights for a certain beam ID, the network node 16 changes the is_new_precoder flag to a one (e.g., true). The network node 16 may change the precoding weights for the same beam ID again and/or change the is_new_precoder flag back to a zero again. In some embodiments, it is assumed that beam ID update guard period X starts when the WD 22 enter the cells and ends when the WD 22 leaves the cell. In addition, the beam ID update guard period X may re-start every time the network node 16 has made a beam pattern update of the configured beam IDs.

A beam ID update guard period of X (such as given in seconds/minutes/hours/days) may be defined and/or dynamically configured by the network node 16. In some embodiments, the beam ID update guard period of X is defined from when the WD 22 entered the cell and/or from when the network node 16 last updated the beam patterns for the configured beam IDs.

A set of unique beam IDs may be specified using n-bits, which may be standardized. For example, 32 unique beam IDs using n=5 bits per ID may be supported. An additional bit such as is_new_precoder may be appended to each beam ID (making the IDs n+1 bits long). For example, the is_new_precoder bit may be appended to the end of the beam ID. Or the additional bit is_new_precoder may be signaled in a separate bitfield. The network node 16 may assign a unique beam ID to each SSB/CSI-RS precoder, using standardized or proprietary methods. For example, the network node 16 may maintain a beam ID-to-precoder table that associates different beam IDs with different SSB/CSI-RS precoders. Further, the network node 16 may use the is_new_precoder flag to indicate to the WD 22 that the precoder for the SSB/CSI-RS has recently changed. Thus, in some embodiments, the network node 16 may be configured to set is_new_precoder to true or false as described above.

In addition, beam IDs (including the is_new_precoder flag) may be made available to the WD 22 whenever the WD 22 measures the corresponding SSBs/CSI-RSs. For example, the beam IDs may be signaled explicitly as part of a CSI report configuration, broadcast as part of initial access, or signaled implicitly via an enhanced TCI state (such as the beam ID may be configured in a TCI state, and the WD 22 may assume that the beam ID is associated with a source reference signal in that TCI state).

Note that it is possible that WD/chipset vendors may collect data from many different devices in a cell over time. The WD/chipset vendor may fuse information about beam ID precoder updates from many different WDs 22 (increasing the probably that the “precoder change” event is correctly labelled in the WD/chipset vendor's measurements). The WD/chipset vendor may use proprietary or standardized methods to label the collected data appropriately and train/retrain AI/ML models, e.g., based on the beam IDs and is_new_precoder flag.

The above solution may assume that the network node 16 updates its SSB/CSI-RS beamforming configurations (precoding vectors) rather infrequently. It may also assume that the guard interval is large enough to ensure that the WD/chipset vendor observes an SSB/CSI-RS “precoder change event” with high probability; that is, at least one WD 22 observes the is_new_precoder flag=1 for each beam ID precoder update.

For example, to allow more frequent SSB/CSI-RS configuration updates, the is_new_precoder Boolean flag attached to, or associated with, each beam ID may be replaced with an m-bit precoder update counter. In this case, the beam ID update guard interval may be removed. The network node 16 may increment the precoder update counter each time it changes the precoder associated with the beam ID. For example, a 5-bit beam ID with an m=2 bit counter (7 bits in total) may be used. The following table shows how the network node 16 may be configured to sequentially increment the precoder update counter for beam ID 0000 as the associated precoder is changed from w_1 to precoder w_2 to precoder w_3 (and so on). The WD/chipset vendor may combine the beam ID and counter information as meta data for its SSB/CSI-RS measurements.

TABLE 1
Example time, precoder, beam ID, and precoder update counters.

| | | (Beam ID, |
|---|---|---|
| | | Precoder update |
| Time | Precoder | counter) |
| T1 | w₁ | (00000, 00) |
| T2 | w₂ | (00000, 01) |
| T3 | w₃ | (00000, 10) |
| T4 | w₄ | (00000, 11) |
| T5 | w₅ | (00000, 00) |

As used herein, the term beam or beam pattern may correspond to downlink spatial filtering coefficients. When a beam or beam ID is configured or indicated to the WD 22 or reported by the WD 22, the beam ID/beam may be represented by a reference signal index. The reference signal may, for example, be a channel state information reference signal (CSI-RS) (in which case the beam/beam ID may be represented by a CSI-RS resource index, CRI) and/or an SSB (in which case the beam/beam ID may be represented by an SSB resource index, SSBRI).

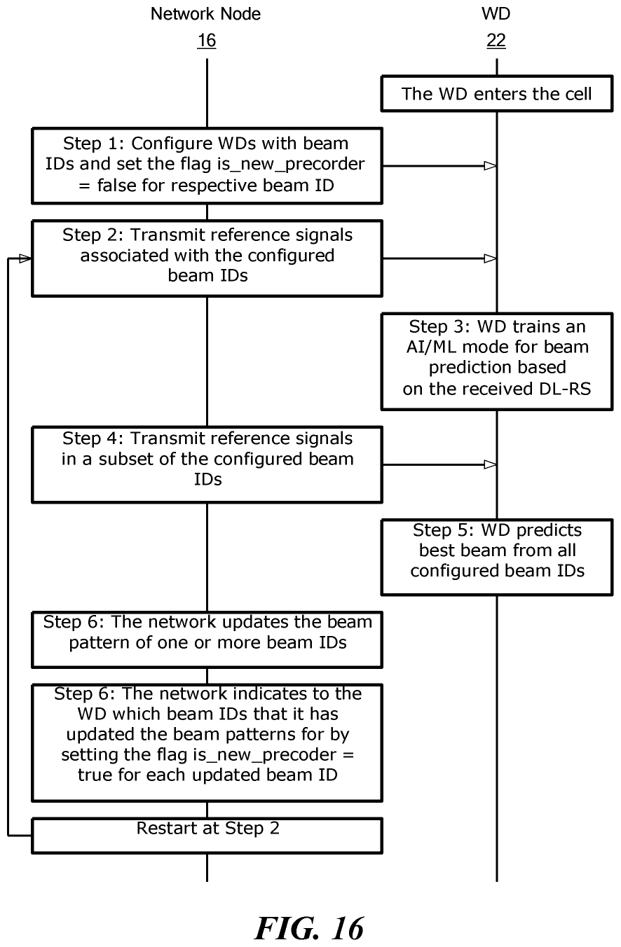

FIG. 16 is a flowchart of an example process according to some embodiments. Assume that the WD 22 enters the cell. In Step 1, the network node 16 configures the WD 22 with beam IDs, where each beam ID may be associated with a flag is_new_precoder (which is set to false). In Step 2, the network node 16 transmits reference signals in the configured beam IDs. At Step 3, the WD 22 collects data to train an AI/ML beam prediction model. At Step 4, the network node 16 transmits a subset of the configured beam IDs. At Step 5, the WD 22 uses the AI/ML model to predict a beam from all the beam IDs. At Step 6, the network node 16 decides to update the beam patterns for one or more beam IDs. At Step 6A, for a WD 22 that is already configured with the beam IDs, the WD 22 gets an indication from the network node 16 that the beam patterns for the corresponding beam IDs have been updated. This may be signaled, for example, by setting the is_new_precoder flag for the corresponding beam IDs to 1. The signaling may be DCI, MAC-CE or RRC signaling. The process may continue at Step 2, where the WD 22 may re-train the AI/ML model for the update beam IDs.

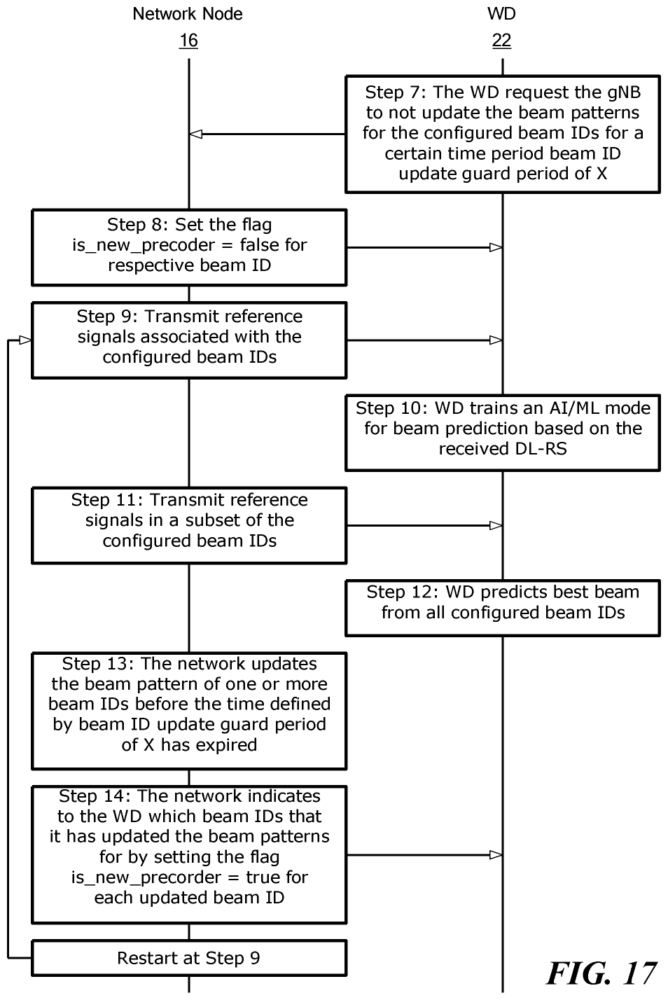

FIG. 17 shows another example process according to some embodiments of the present disclosure. At Step 7, a WD 22 that is served by a network node 16 requests the network node 16 to not update the beam patterns of the beam IDs that the WD 22 has been configured with (e.g., for a certain time period defined by a parameter beam ID update guard period of X). At Step 8, the network node 16 configures all beam IDs for the WD 22 (and/or for all WDs 22 belonging to the same WD/chipset vendor served by that network node 16) with the flag is_new_precoder set to false for a respective beam ID. When the timer beam ID update guard period of X has expired, if the network node 16 updates the beam patterns for one or more of the configured beam IDs, the network signals to the WD 22 (and/or to all the WDs 22 of the same WD/chipset vendor served by that network node 16 (e.g., gNB, cell)) that it has changed the beam patterns for one or more beam IDs, e.g., by setting the flag is_new_precoder to true (or logical one, for example). At step 9, the network node 16 transmits reference signals associated with the configured beam IDs. At Step 10, the WD trains an AI/ML model for beam prediction based on the received downlink reference signals. At Step 11, the network node transmits reference signals in a subset of the configured beam IDs. At Step 12, the WD predicts a best beam among all the configured beam IDs. At Step 13, the network node 16 updates the beam pattern of one or more beam IDs before a time defined by the beam ID update guard period of X has expired. At Step 14, the network node 16 indicates to the WD the updated beam IDs for which the beam patterns have been updated by the network node 16 by setting the is_new_precoder flag to true for each updated beam ID.

In some embodiments, the beam IDs may be (e.g., standardized as) part of a CSI-RS resource. The beam IDs may be introduced by extending a current measurement RS resource configuration, e.g., as a part of the NZP-CSI-RS-Resource information element (IE).

The following are examples of how to extend the current NZP-CSI-RS-Resource IE to support indicating the beam ID, e.g., by defining a new field “beam ID”. In the example, the ID may be defined by a 6-bit value (0-31), and the is_new_precoder flag is indicated by a Boolean value.

### NZP-CSI-RS-Resource

The IE NZP-CSI-RS-Resource may be used to configure Non-Zero-Power (NZP) CSI-RS transmitted in the cell where the IE is included to indicate to the WD 22 the NZP CSI-RS to measure on (e.g., 3GGP Technical Standard (TS) 38.214, clause 5.2.2.3.1). In some embodiments, a change of configuration between periodic, semi-persistent or aperiodic for an NZP-CSI-RS-Resource may not be supported without a release and add.

TABLE 2
Example NZP-CSI-RS-Resource field descriptions.
NZP-CSI-RS-Resource information element
-- ASN1START
-- TAG-NZP-CSI-RS-RESOURCE-START

| | |
|---|---|
| NZP-CSI-RS-Resource ::= | SEQUENCE { |
| nzp-CSI-RS-ResourceId | NZP-CSI-RS-ResourceId, |
| beamID | BEAM-ID, |
| resourceMapping | CSI-RS-ResourceMapping, |
| powerControlOffset | INTEGER (−8..15), |
| powerControlOffsetSS | ENUMERATED{db−3, db0, db3, db6} |

OPTIONAL, -- Need R

| | |
|---|---|
| scramblingID | ScramblingId, |
| periodicityAndOffset | CSI-ResourcePeriodicityAndOffset |

OPTIONAL, -- Cond PeriodicOrSemiPersistent

| | |
|---|---|
| qcl-InfoPeriodicCSI-RS | TCI-StateId |

OPTIONAL, -- Cond Periodic
...
}
BEAM-ID ::= {

| | |
|---|---|
| Beam-ID | Integer (0..32) |
| is_new_precoder | Boolean |

}
-- TAG-NZP-CSI-RS-RESOURCE-STOP
-- ASN1STOP

NZP-CSI-RS-Resource field descriptions
periodicityAndOffset
Periodicity and slot offset sl1 corresponds to a periodicity of 1 slot, sl2 to a
periodicity of two slots, and so on. The corresponding offset is also given in
number of slots (see 3GPP TS 38.214, clause 5.2.2.3.1). Network configures the
WD 22 with a value for this field for periodic and semi-persistent NZP-CSI-RS-
Resource (as indicated in CSI-ResourceConfig).
powerControlOffset
Power offset of PDSCH RE to NZP CSI-RS RE. Value in dB (e.g., 3GPP TS
38.214, clauses 5.2.2.3.1 and 4.1).
powerControlOffsetSS
Power offset of NZP CSI-RS RE to SSS RE. Value in dB (e.g., 3GPP TS 38.214,
clause 5.2.2.3.1).
qcl-InfoPeriodicCSI-RS
For a target periodic CSI-RS, contains a reference to one TCI-State in TCI-States
for providing the QCL source and QCL type. For periodic CSI-RS, the source
may be SSB or another periodic-CSI-RS. Refers to the TCI-State which has this
value for tci-StateId and is defined in tci-StatesToAddModList in the PDSCH-
Config included in the BWP-Downlink corresponding to the serving cell and to
the DL BWP to which the resource belongs to (e.g., 3GPP TS 38.214, clause
5.2.2.3.1).
resourceMapping
OFDM symbol location(s) in a slot and subcarrier occupancy in a PRB of the
CSI-RS resource.
scramblingID
Scrambling ID (e.g., 3GPP TS 38.214, clause 5.2.2.3.1).
Beam ID
Unique identifier which enables predictability of the effective channel for an ML-
capable device
is_new_precoder

| | |
|---|---|
| ◯ | False - then the UE may assume that the precoder for this beam ID |
| | has not changed during the beam ID update guard period |
| ◯ | True - then the UE may assume that the precoder for this beam ID |
| | has changed during the beam ID update guard period. |

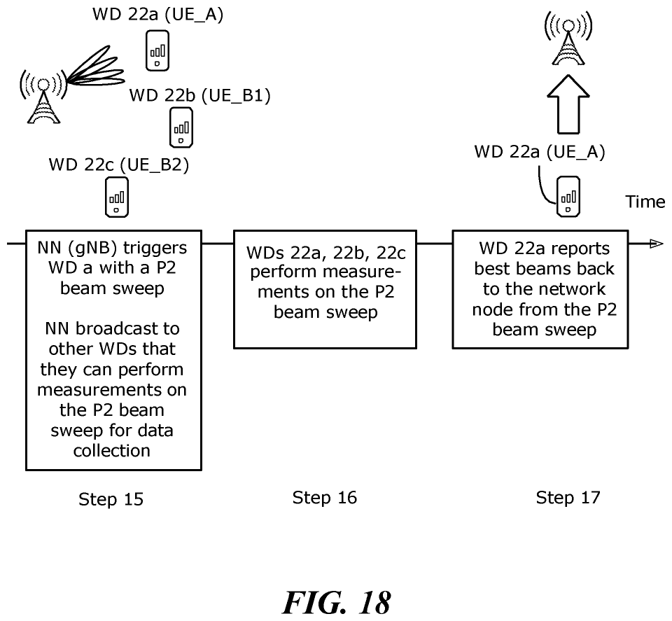

FIG. 18 shows an example process according to some embodiments of the present disclosure. At Step 15, the network node 16 may trigger WD 22a with a P2 beam sweep. network node 16 may broadcast to other WDs 22 that they may perform N measurements on the P2 beam sweep for data collection. At Step 16, at least one of the WDs 22a, 22b, 22c may perform measurements on the P2 beam sweep. At Step 17, WD 22a may report a set of one or more best beams back to the network node 16 from the P2 beam sweep.

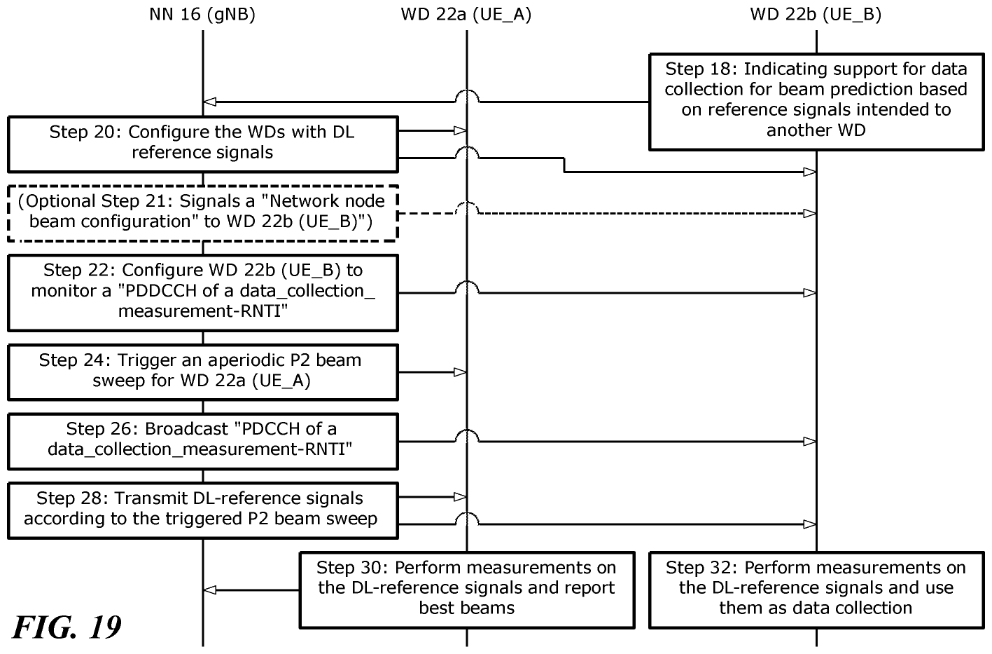

FIG. 19 shows another example process according to some embodiments of the present disclosure. At Step 18, WD 22b indicates support for data collection for beam prediction based on reference signals intended to another WD 22. At Step 20, the network node 16 configures the WDs 22 with DL reference signals. At (optional) Step 21, the network node 16 signals a “Network node beam configuration” to WD 22b (UE_B). At Step 22, the network node 16 configures WD 22b (UE_B) to monitor a “PDCCH of a data_collection_measurement-RNTI”. At Step 24, the network node 16 triggers an aperiodic P2 beam sweep for WD 22a (UE_A). At Step 26, the network node 16 broadcast “PDCCH of a data_collection_measurement-RNTI”. At Step 28, the network node 16 transmit DL-reference signals according to the triggered P2 beam sweep. At Step 30, WD 22a may perform measurements on the DL-reference signals and report best beams. At Step 32 the WD 22b performs measurements on the DL-reference signals and uses them as part of a data collection process.

Some embodiments may include one or more of the following:

Embodiment A1. A network node configured to communicate with a wireless device, WD, the network node configured to, and/or comprising a radio interface and/or comprising processing circuitry configured to:
transmit a configuration to the WD, the configuration including a set of beam identifiers, each beam identifier of the set of beam identifiers having a precoder flag set to false;
update a beam pattern of one or more beam identifiers of the set of beam identifiers; and
transmit an indication to the WD indicating the updated beam pattern of the one or more beam identifiers, the indication having the precoder flag set to true for the one or more beam identifiers, the precoder flag being true triggering the WD to determine that a precoder for the corresponding beam identifier has changed before a beam update guard period expires.

Embodiment A2. The network node of Embodiment A1, wherein the network node and/or the radio interface is further configured to:
receive a request from the WD for the network node not to update, during the beam update guard period, the beam pattern for the set of beam identifiers.

Embodiment A3. The network node of any one of Embodiments A1 and A2, wherein the network node and/or the radio interface is further configured to:
transmit a first set of reference signals associated with the set of beam identifiers, the transmitted first set of reference signals triggering the WD to train a model for beam prediction.

Embodiment A4. The network node of any one of Embodiments A1-A3, wherein the network node and/or the radio interface is further configured to:
transmit a second set of reference signals associated with a subset of the set of beam identifiers, the transmitted second set triggering the WD to predict a best beam from the set of beam identifiers.

Embodiment B1. A method in a network node configured to communicate with a wireless device, WD, the method comprising:
transmitting a configuration to the WD, the configuration including a set of beam identifiers, each beam identifier of the set of beam identifiers having a precoder flag set to false;
updating a beam pattern of one or more beam identifiers of the set of beam identifiers; and
transmitting an indication to the WD indicating the updated beam pattern of the one or more beam identifiers, the indication having the precoder flag set to true for the one or more beam identifiers, the precoder flag being true triggering the WD to determine that a precoder for the corresponding beam identifier has changed before a beam update guard period expires.

Embodiment B2. The method of Embodiment B1, wherein the method further includes:
receiving a request from the WD for the network node not to update, during the beam update guard period, the beam pattern for the set of beam identifiers.

Embodiment B3. The method of any one of Embodiments B1 and B2, wherein the method further includes:
transmitting a first set of reference signals associated with the set of beam identifiers, the transmitted first set of reference signals triggering the WD to train a model for beam prediction.

Embodiment B4. The method of any one of Embodiments B1-B3, wherein the method further includes:
transmitting a second set of reference signals associated with a subset of the set of beam identifiers, the transmitted second set triggering the WD to predict a best beam from the set of beam identifiers.

Embodiment C1. A wireless device, WD, configured to communicate with a network node, the WD configured to, and/or comprising a radio interface and/or processing circuitry configured to:
perform a training of a model for beam prediction based at least in part on a first set of reference signals associated with a set of beam identifiers, each beam identifier of the set of beam identifiers having a precoder flag set to false; and
predict a best beam from the set of beam identifiers based at least in part on the trained model and a second set of reference signals associated with a subset of the set of beam identifiers.

Embodiment C2. The WD of Embodiment C1, wherein at least one of the WD and the radio interface is further configured to:
transmit a request for the network node not to update, during a beam update guard period, a beam pattern for the set of beam identifiers.

Embodiment C3. The WD of Embodiment C2, wherein at least one of the WD and the radio interface is further configured to:
receive an indication indicating an updated beam pattern of one or more beam identifiers of the set of beam identifiers, the indication having the precoder flag set to true for the one or more beam identifiers; and
determine that a precoder for at least one beam identifier has changed before the beam update guard period expired based on the received indication.

Embodiment C4. The WD of any one of Embodiments C1-C3, wherein at least one of the WD and the radio interface is further configured to at least one of:
receive a configuration, the configuration including the set of beam identifiers;
receive the first set of reference signals associated with the set of beam identifiers; and
receive the second set of reference signals associated with the subset of the set of beam identifiers.

Embodiment D1. A method in a wireless device, WD, configured to communicate with a network node, the method comprising:
performing a training of a model for beam prediction based at least in part on a first set of reference signals associated with a set of beam identifiers, each beam identifier of the set of beam identifiers having a precoder flag set to false; and
predicting a best beam from the set of beam identifiers based at least in part on the trained model and a second set of reference signals associated with a subset of the set of beam identifiers.

Embodiment D2. The method of Embodiment D1, wherein the method further includes:
transmitting a request for the network node not to update, during a beam update guard period, a beam pattern for the set of beam identifiers.

Embodiment D3. The method of Embodiment D2, wherein the method further includes:
receiving an indication indicating an updated beam pattern of one or more beam identifiers of the set of beam identifiers, the indication having the precoder flag set to true for the one or more beam identifiers; and
determining that a precoder for at least one beam identifier has changed before the beam update guard period expired based on the received indication.

Embodiment D4. The method of any one of Embodiments D1-D3, wherein the method further includes at least one of:
receiving a configuration, the configuration including the set of beam identifiers;
receiving the first set of reference signals associated with the set of beam identifiers; and
receiving the second set of reference signals associated with the subset of the set of beam identifiers.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
3GPP 3rd Generation Partnership Project
5G Fifth Generation
ACK Acknowledgement
AI Artificial Intelligence
AoA Angle of Arrival
CORESET Control Resource Set
CSI Channel State Information
CSI-RS CSI Reference Signal
DCI Downlink Control Information
DoA Direction of Arrival
DL Downlink
DMRS Downlink Demodulation Reference Signals
FDD Frequency-Division Duplex
FR2 Frequency Range 2
HARQ Hybrid Automatic Repeat Request
ID identity/identifier
gNB gNodeB
MAC Medium Access Control
MAC-CE MAC Control Element
ML Machine Learning
NR New Radio
NW Network
OFDM Orthogonal Frequency Division Multiplexing
PBCH Physical Broadcast Channel
PCI Physical Cell Identity
PDCCH Physical Downlink Control Channel
PDSCH Physical Downlink Shared Channel
PRB Physical Resource Block
QCL Quasi co-located
RB Resource Block
RRC Radio Resource Control
RSRP Reference Signal Strength Indicator
RSRQ Reference Signal Received Quality
RSSI Received Signal Strength Indicator
SCS Subcarrier Spacing
SINR Signal to Interference plus Noise Ratio
SSB Synchronization Signal Block
RL Reinforcement Learning
RS Reference Signal
Rx Receiver
TB Transport Block
TDD Time-Division Duplex
TCI Transmission configuration indication
TRP Transmission/Reception Point
Tx Transmitter
UE User Equipment
UL Uplink
WD Wireless Device

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to communicate with a wireless device, WD, the network node configured to:
configure a beam ID update guard period during which the WD is configured to assume that a same network node spatial filter is used during the beam ID update guard period unless otherwise indicated by the network node; and
transmit an indication of the configuration to the WD.

2.-14. (canceled)

15. A method in a network node configured to communicate with a wireless device, WD, the method comprising:
configuring a beam ID update guard period during which the WD is configured to assume that a same network node spatial filter is used during the beam ID update guard period unless otherwise indicated by the network node; and
transmitting an indication of the configuration to the WD.

16. The method of claim 15, further comprising: updating an association between beam patterns and a set of beam identifiers during a beam ID update guard period; and
transmitting to the WD an indication of the association when the beam ID update guard period has expired.

17. The method of claim 16, further comprising updating a beam pattern identified by at least one beam identifier of the set of beam identifiers.

18. The method of claim 16, further comprising triggering the WD (22) to determine a precoder for a corresponding beam identifier of the set of beam identifiers for which the association has been updated.

19. The method of claim 16, further comprising receiving a request from the WD for the network node not to update a beam pattern for the set of beam identifiers during the beam ID update guard period.

20. The method of claim 16, further comprising transmitting a first set of reference signals associated with the set of beam identifiers, the transmitted first set of reference signals triggering the WD to train a beam prediction model to predict a best beam.

21.-28. (canceled)

29. A wireless device, WD, configured to communicate with a network node, the WD configured to:
receive from the network node a configuration of a beam ID update guard period; and
assume that the network does not change the spatial filter associated with a set of beam identifiers during the beam ID update guard period unless indicated otherwise by the network node.

30.-40. (canceled)

41. A method in a wireless device, WD, configured to communicate with a network node, the method comprising:
receiving from the network node a configuration of a beam ID update guard period; and
assuming that the network does not change the spatial filter associated with a set of beam identifiers during the beam ID update guard period unless indicated otherwise by the network node.

42. The method of claim 41, further comprising receiving a precoder flag, the precoder flag indicating whether a beam pattern associated with a set of beam identifiers has been updated during a beam ID update guard period.

43. The method of claim 42, further comprising, when the precoder flag indicates that a beam pattern associated with the set of beam identifiers has been updated:
training a beam prediction model based at least in part on a first set of reference signals associated with the set of beam identifiers, each beam identifier of the set of beam identifiers having a precoder flag set to one of true and false.

44. The method of claim 43, further comprising transmitting a request for the network node not to update a beam pattern for the set of beam identifiers during the beam update guard period.

45. The method of claim 42, further comprising receiving the first set of reference signals and receive a second set of reference signals associated with a subset of the set of beam identifiers.

46. The method of claim 45, further comprising training the beam prediction model in response to receiving the first set of reference signals.

47. The method of claim 46, further comprising training the beam prediction model in response to receiving the second set of reference signals.

48. The method of claim 42, wherein the precoder flag is appended to an n-bit field, each bit in the n-bit field being set to true when an associated beam has been updated and being set to false when the associated beam has not been updated.

49. The method of claim 42, further comprising receiving an indication of beams that have been updated in a channel state information, CSI, report.

50. The method of claim 42, further comprising receiving a configuration of beams that have been updated in a transmission configuration indicator, TCI, state.

51. The method of claim 42, wherein the first set of reference signals is indicated by at least one of a reference signal index or a synchronization signal/physical broadcast channel, SSB, resource index.

52. The method of claim 42, further comprising predicting a best beam based at least in part on the trained model and the first set of reference signals.
